(19) United States
(12) Patent Application Publication
(10) Pub. No.: US 2025/0206010 A1
(43) Pub. Date: Jun. 26, 2025

(54) FILM APPLICATION METHOD FOR CONSTRUCTION PANELS

(71) Applicant: Trade Fabrication Systems Limited, Woolston (GB)

(72) Inventor: Howard M. Morris, Upholland (GB)

(73) Assignee: Trade Fabrication Systems Limited, Woolston (GB)

(21) Appl. No.: 18/848,584

(22) PCT Filed: Mar. 17, 2023
(86) PCT No.: PCT/GB2023/050652

§ 371 Date: Sep. 19, 2024

(30) Foreign Application Priority Data
Mar. 21, 2022 (GB) 2203919.2

(51) Int. Cl. B32B 37/12; B32B 3/02; B32B 3/30; B32B 7/12; B32B 21/02; B32B 21/08; B32B 37/24; E04C 2/12

(52) U.S. Cl. CPC B32B 37/1284; B32B 3/02; B32B 3/30; B32B 7/12; B32B 21/02; B32B 21/08; B32B 37/24; E04C 2/12; B32B 2037/243; B32B 2255/08; B32B 2255/26; B32B 2307/718; B32B 2309/02; B32B 2309/12; B32B 2317/16; B32B 2607/00

(57) ABSTRACT

The present invention relates to a method of applying a protective film to a construction panel. In particular, applying a protective film to a construction panel having an outer layer that comprises overlapping wood strands. The invention also relates to a protected construction panel per se.

### CROSS REFERENCE TO RELATED APPLICATIONS

This application is a national stage application, filed under 35 U.S.C. § 371, of International Patent Application No. PCT/GB2023/050652 filed on Mar. 17, 2023, which claims benefit of and priority to British Patent Application No. 2203919.2 filed on Mar. 21, 2022, which are incorporated herein by reference in their entirety.

### FIELD OF INVENTION

The present invention relates to a method of applying a protective film to a construction panel. In particular, applying a protective film to a construction panel having an outer layer that comprises overlapping wood strands. The invention also relates to a protected construction panel per se.

### BACKGROUND

Construction panels are commonly used to construct flooring and roofing in new buildings. During construction of the new buildings, the flooring is often installed early on in the building process to enable construction workers to walk around the construction site safely. This means that the construction panels are installed, as flooring, before the windows, walls or roof of the building are installed. Similarly, construction panels may be used as the only roofing of new buildings during the early stages of a construction project to provide coverage of the construction site. In both situations, damage can be caused to the construction panels due to the ingress of rain, wind and general exposure to the surrounding environment. In addition, prior to installing the floor or roof, the construction panels may be stored in the open for a prolonged period during which time they may suffer from weathering damage which can impact on the structural integrity of the panel.

To overcome these issues, it is possible to apply a temporary or permanent protective film or layer to a surface (e.g. top/bottom surface) of the construction panels (e.g. structural building panels) to protect the panels from damage and water ingress, at least, whilst the construction of the building is ongoing. The protective film can then be removed once construction has finished, providing an undamaged construction panel for long-term use.

Various methods for improving the application of a protective film to a construction panel are known in the art. For example, GB2558603 describes applying an adhesive composition to a peripheral region of a surface of the construction panel to prevent lifting or peeling away of the protective film at the edges of the panel.

Construction panels that are used as flooring within the construction industry have typically been composed of chipboard. The temporary protection of these chipboard construction panels using the method described in GB2558603 is known to be highly effective. However, recently there has been an increase in demand for chipboard in other industries, such as the furniture industry, resulting in a reduction in the availability of chipboard for use as construction panels. This has created a demand for construction panels made from alternative materials, for example, Oriented Strand Board (OSB).

Orient Strand Board (OSB) is an engineered wood-based material in which long strands (or strips) of wood are bonded together with a synthetic resin adhesive. The wood strands typically lie unevenly across each other but are predominantly orientated in a particular direction, more often than not, oriented such that they align with the longest dimension of the panel. In example OSB panels, the individual wood strands typically have dimensions of around 2.5 cm×7.5 cm. Typical resins include urea-formaldehyde, melamine-urea-formaldehyde or phenol formaldehyde. The overlapping wood strands result in a rough, uneven and variegated outer surface, with a plurality of recesses, also known as holes or pits, formed between the stands. This contrasts to chipboard, which has a much smoother, flatter surface, due to small size of the wood chips and the larger amount of resin used to form the material.

Unfortunately, it has been found that the temporary protection of construction panels formed from OSB, or similar materials comprising overlapping wood strands, using protective films is less effective than for chipboard. Specifically, it has been found that, once applied, removal of a protective film applied to an OSB substrate can result in generation of a “splintered” surface that is rough or sharp due to the lift up or peeling away of wood strands on the outer surface of the OSB. Without wishing to be bound by theory, it is believed that it is the nature of manufacture and resin content of OSB substrates (reduced resin compared to chipboard) that results in the potential for the wood strands to splinter or delaminate in use. The splintering presents a serious health and safety risk, and is undesirable to the end user. The panels have also been observed to suffer from an increase in water ingress once the protective film has been removed and the wood strands are peeled away from the outer surface of the OSB. This water ingress can cause serious structural degradation and surface damage to the panel (e.g. an uneven expansion of the material). This can have major cost implications for the builders and the construction industry as a whole.

It is an object of the present invention to obviate or mitigate at least one or more of the above-mentioned disadvantages.

It is for instance desirable to provide a method of protecting a construction panel, e.g. an OSB construction panel, such that upon removal of the protective film, the construction panel has a safe surface for subsequent use. It is also desirable if the construction panel continues to be protected from water ingress after removal of the protective film.

### SUMMARY OF THE INVENTION

In general, the present invention proposes a unique method for applying a temporary protective film and to provide a sealed surface to a construction panel that has an outer layer comprising overlapping wood strands and a plurality of recesses formed between the overlapping wood strands. The method involves at least two adhesive application steps. The first adhesive application step involves filling (and sealing) the recesses (e.g. pits or voids) present in the outer layer of the panel, whilst the second adhesive application step provides a suitable bonding surface for bonding the protective film. Advantageously, it has been found that a construction panel, and in particular a OSB construction panel, protected according to the method of the present invention undergoes protective film removal without significant splintering of the outer layer of the construction panel, or at least at a highly reduced amount of splintering as compared to the removal of a protective film from a panel that has been applied via methods known in the art.

It has been found that conventional methods used for protecting construction panels including an outer layer with overlapping wood strands and a plurality of recesses formed between the overlapping wood strands fail to either (i) apply a sufficient amount of adhesive in order to fill and seal the recesses formed between the wood strands in the outer layer or (ii) involve the application of excessive amounts of the adhesive to the surface of the outer layer. The former involves applying lower coat weights of adhesive in order to establish a temporary adhesive with a protective film. This can however lead to wood strands being easily moved or pulled away from the outer layer of the construction panel during removal of the protective film. The latter involves the application of much higher coat weights of adhesive which tends to result in the protective film being too strongly bonded to the outer layer of the panel, thus preventing a temporary adhesion. That is, temporary adhesion of the protective film to the construction panel including sealing of the surface is desirable for applications such as structural flooring however excessive amounts of adhesive can lead to bond strengths which prohibit easy removal of the film by the end user. The use of excessive amounts of adhesive also greatly increases the costs associated with the film application method. This is because a greater volume of adhesive is required and additional processing steps are also necessary to remove/clean excess adhesive material from the panel surface. In contrast, the method of the present invention provides a cost effective method to protect a structural panel during construction and provide a surface suitable for foot traffic (including bare feet) prior to floor coverings such as carpet, vinyl or laminate/wood planking.

Without wishing to be bound by theory, it is believed that the adhesive application steps forming part of the method described herein act to ensure that the individual wood strands found in the outer layer of the construction panel are strongly bound to the body of the construction panel. In other words, by utilising the adhesive application steps of the method described herein, the overlapping wood strands forming part of the outer layer of the construction panel can be “locked in” thus preventing splintering of the outer layer upon removal of a protective film from the surface of the panel. In particular, by filling the recesses forming part of the outer layer of the panel, the overlapping wood strands are strongly fixed to the body of the construction panel thus reducing their propensity to lift and peel away during protective film removal. In addition, the filling of the recesses with adhesive is performed to allow for the generation of a uniform and homogeneous adhesive outer layer on the surface of the panel. This uniform outer layer remains on the outer surface of the panel after removal of the protective film by the end user (i.e. the recesses remain filled) and provides a water impermeable barrier on the panel surface thus reducing moisture ingress during use.

In summary, the present inventors have developed a method of applying a protective film to a construction panel which involves carefully balancing the adhesive application protocol to allow for a surprising and unexpected bonding finish between the construction panel and a protective film. As will become further apparent from the technical details described herein, the protective film becomes sufficiently bonded to the outer surface of the panel so as to remain in place and prevent water ingress during use but whilst also being easily removed without splintering of the construction panel outer layer. Moreover, the method described herein can also be conducted on a single production line leading to a range of process efficiencies and high throughput of final construction panel products.

In a first aspect of the present invention there is provided a method of applying a protective film to a construction panel, the construction panel comprising an outer layer, the outer layer comprising overlapping wood strands and a plurality of recesses formed between the overlapping wood strands, wherein the method comprises the steps of a) applying a first adhesive composition to the outer layer to fill the plurality of recesses with the first adhesive composition to provide a uniform outer layer; b) applying a second adhesive composition to the uniform outer layer to provide a bonding surface; and c) applying the protective film to the bonding surface to bond the protective film to the construction panel.

The term “construction panel” is intended to indicate a structural building element suitable for use in the construction of a building. The panel is typically rectangular in shape. Where the construction panel is rectangular in shape, there is a long edge, a short edge, a top surface, a width defined by a measurement extending orthogonally from one long edge across the top surface to the other long edge and a length defined by a measurement extending orthogonally from one short edge across the top surface to the other short edge. Where the construction panel is a square, the edges of the panel will be equal in length and its width is defined by a measurement extending orthogonally across a top surface between opposing edges. Typically, the construction panels may have a panel width of from about 300 mm to about 1400 mm, panel length of from about 1000 mm to about 5000 mm and a panel height/thickness of from about 3 mm to about 100 mm. More preferably, the construction panels may have a panel width of about 600 mm, panel length of from about 2400 mm and a panel height/thickness of about 22 mm. The construction panels may also include a suitable installation system which allows separate construction panels to be connected to one another in order to form a larger surface, such as a floor, ceiling or roof. For example, the construction panels may include tongue and groove profiled edges to allow for the connecting of separate panels together.

The term “wood strand” is intended to indicate single elongated fragment composed of a wood material. Wood strands are also commonly referred to as wood flakes. The strands may be of any elongated shape, such as rectangular or triangular. In some embodiments, the wood strands are an elongated irregular shape. It will be appreciated that the strands are larger than woodchips commonly used in chipboard (also known as particleboard). It will also be appreciated that size of the wood strands can be defined by their length, width and thickness, where the length corresponds to their longest dimension. Typically, the length will correspond to the grain direction of the wood while the width runs across the grain.

In embodiments, the wood strands have a length of from about 25 mm to about 250 mm. In some embodiments, the wood strands have a length of from about 40 mm to about 250 mm, from about 60 mm to about 250 mm, from about 75 mm to about 250 mm, from about 25 mm to about 200 mm, from about 25 mm to about 150 mm, from about 25 mm to about 100 mm, from about 25 mm to about 75 mm, from about 30 mm to about 200 mm, from about 40 mm to about 175 mm, from about 50 mm to about 150 mm, from about 50 mm to about 100 mm, from about 50 mm to about 75 mm. Preferably, the wood strands have a length of from about 50 mm to about 150 mm,

In embodiments, the wood strands have a width of from about 2.5 mm to about 75 mm, In some embodiments, the wood strands have a width of from about 5 mm to about 75 mm, from about 10 mm to about 75 mm, from about 15 mm to about 75 mm, from about 2.5 mm to about 50 mm, from about 2.5 mm to about 40 mm, from about 5 mm to about 75 mm, from about 10 mm to about 75 mm, from about 15 mm to about 75 mm, from about 15 mm to about 50 mm, from about 10 mm to about 40 mm, from about 15 mm to about 40 mm. Preferably, the wood strands have a width of from about 5 mm to about 50 mm.

In embodiments, the wood stands have a length of from about 25 mm to about 250 mm and a width of from about 2.5 mm to about 75 mm. In further embodiments, wood stands have a length of from about 50 mm to about 200 mm and a width of from about 5 mm to about 50 mm. In still further embodiments, the wood stands have a length of from about 50 mm to about 150 mm and a width of from about 10 mm to about 40 mm.

In embodiments, the wood strands have a thickness of from about 0.05 mm to about 2 mm, In some embodiments, the wood strands have a thickness of from about 0.1 mm to about 2 mm, from about 0.2 mm to about 2 mm, from about 0.3 mm to about 2 mm, from about 0.05 mm to about 1.5 mm, from about 0.05 mm to about 1 mm, from about 0.05 mm to about 0.7 mm, from about 0.1 mm to about 1.5 mm, from about 0.2 mm to about 1 mm, from about 0.3 mm to about 1 mm, from about 0.3 mm to about 0.7 mm. Preferably, the wood strands have a width of from about 0.2 mm to about 1 mm.

In embodiments, the wood stands have a length of from about 25 mm to about 250 mm, a width of from about 2.5 mm to about 75 mm and a thickness of from about 0.05 mm to about 2 mm. In other embodiments, the wood stands have a length of from about 50 mm to about 200 mm, a width of from about 5 mm to about 50 mm and a thickness of from about 0.1 mm to about 1 mm. In further embodiments, the wood stands have a length of from about 50 mm to about 150 mm, a width of from about 10 mm to about 40 mm and a thickness of from about 0.2 mm to about 1 mm.

The term “recess” is intended to indicate an unfilled gap, void, pit or depression present in the panel surface. In particular, a void that extends into the construction panel from an outer surface of the construction panel. The outer surface being defined by the plane formed from the exposed surfaces of the uppermost wood strands in the outer layer construction panel. For avoidance of doubt, such recesses do not contain any wood material or resin and arise due to the overlapping orientation of the wood strands forming the outer layer. Such recess do not occur in chipboard due to the small size of the wood chips and the large amount of resin used to bind the chips together. An exemplary recess can be found depicted in FIGS. 1 and 3 as labelled by reference numerals (4) and (34), respectively.

The term “adhesive composition” is intended to indicate any substance applied to a surface of one, or both, of two separate articles (e.g. a bonding surface formed on a construction panel and a surface of a protective film) to bond them together to resist their separation. As it will be appreciated, the term “bond” or “bonding” refers to the fixing or securing of two separate surfaces together. This may include the formation of covalent bonds, ionic bonds, dipole-dipole bonding, hydrogen-bonding, Van der Waal forces or alike. A “bonding surface” represents a surface suitable for fixing the protective film to the construction panel. The term “adhesive composition” may be used interchangeably with the term “adhesive” for the purposes of this invention.

The term “uniform outer layer” is intended to indicate a layer that has a flat, smooth surface. The uniform outer layer includes an adhesive composition which fills the plurality of recesses formed between the wood strands. In some embodiments, this (first) adhesive composition completely fills the plurality of recesses formed between the wood strands. In other embodiments, the first adhesive composition partially or substantially fills the plurality of recesses formed between the wood strands. It will be appreciated, that where the adhesive composition only partially or substantially fills the plurality of recesses, the recesses are still filled to an extent sufficient to generate a uniform outer layer that has a generally flat and smooth surface. Without wishing to be bound by theory, it is believed that generation of this uniform outer layer ensures that the wood strands become “locked in” place by the first adhesive composition. In some embodiments, in addition to filling (e.g. completely filling) the recesses, the adhesive composition covers, or encapsulates, the uppermost surface of the woods strands to generate the uniform outer layer. An exemplary uniform outer layer can be seen depicted in FIG. 3 as labelled by reference numeral (36). As used above, the term “surface” may refer to a top surface and/or bottom surface but does not include the outward facing edges of the construction panel.

The term “protective film” is intended to refer to any sheet-like material which when applied and bonded to the surface of a construction panel provides a barrier to protect the surface of the construction panel from damage, for example, physical impact, water ingress or UV light exposure. The term “protective film” may be used interchangeably with the term “protective film layer” for the purposes of this invention.

In embodiments of the present invention, the construction panel is Oriented Strand Board (OSB). For example, the construction panel may be any type of Oriented Strand Board as defined by European Standard EN300 (OSB-Definitions, classification and specifications). OSB is considered to be one of the most viable replacement materials for the chipboard panels commonly used as construction panels. OSB panels also show highly favourable mechanical properties that make it particularly suitable for load-bearing applications in construction. However, it is known to have issues related to the removal of a temporary protective film. The present invention has been observed to be particularly effective for overcoming this disadvantage in OSB construction panels. In other embodiments of the present invention, the construction panel is a non-Orientated Strand Board, for example, Waferboard.

In embodiments of the present invention, the plurality of recesses formed between the overlapping wood strands in the outer layer have a depth of from about 0.25 mm to about 20 mm or from about 0.5 mm to about 20 mm, e.g. of from about 1 mm to about 10 mm, such as, of from about 2 mm to about 8 mm. Preferably, the plurality of recesses in the outer layer have a depth of from about 1 mm to about 20 mm, from about 1 mm to about 15 mm, from about 5 mm to about 20 mm, from about 10 mm to about 20 mm. In embodiments, the plurality of recesses in the outer layer have a depth of from about 2 mm to about 10 mm, from about 3 mm to about 10 mm, from about 4 mm to about 10 mm, from about 5 mm to about 10 mm, from about 6 mm to about 10 mm, from about 8 mm to about 10 mm, from about 2 mm to about 9 mm, from about 2 mm to about 8 mm, from about 2 mm to about 7 mm, from about 2 mm to about 6 mm or from about 2 mm to about 4 mm or from about 3 mm to about 7 mm. Even more preferably, the plurality of recesses in the outer layer have a depth of from about 4 mm to about 6 mm. The depth of the recesses refers to the maximum distance the recess extends into the construction panel from the outer surface of the construction panel. It will be appreciated that the recess depths described herein are commonly found in engineered wood materials comprising overlapping wood strands, such as Oriented Strand Board or Waferboard.

In embodiments of the present invention, the overlapping wood strands are selected from any suitable type of wood strand or a combination of one or more suitable types of suitable wood strand. In other embodiments, the overlapping wood strands are selected from the group consisting of spruce wood strands, fir wood strands, pine wood strands, larch wood strands, beech wood strands, aspen wood strands, birch wood strands, willow wood strands, alder wood strand or any combination thereof. In embodiments, the wood strands comprise recycled timber.

In embodiments of the present invention, the method further comprises drying the uniform outer layer before applying the second adhesive composition. It will be appreciated that drying the uniform outer layer may in some embodiments act to ensure that the wood strands become “locked in” place by the first adhesive composition. The nature and duration of the drying step will depend on a number of factors, for example, the type of constructional panel being protected and the adhesive composition used. Indeed, in some instances, the drying step provides a sufficient amount of time to allow for the adhesive composition to flow into the plurality of recesses and fill the plurality of recesses before then suitably curing. The curing (or setting) of the adhesive causes the locking in and securing of the wood stranding in the outer layer. The drying step may also allow for the creation of a more stable uniform outer layer on which application of the second adhesive composition can be performed. This can advantageously lead to an improved bonding surface.

The drying step may be any suitable method known in the art and will depend on the type of adhesive composition used. For example, drying by exposure to air, drying by movement of air across the uniform outer layer (e.g. using a fan), or drying by heating the uniform outer layer. The term “drying” is intended to refer to the curing (or setting) or partial curing of an adhesive composition. In some embodiments, the drying step may be performed using a convention oven, radiant gas heaters or fan dryers. In such embodiments, the drying may be performed at an elevated temperature, for example, at a drying temperature of from about 40° C. to about 100° C. or from about 50° C. to about 80° C. In other embodiments, where a hot melt adhesive is used, the drying or the curing step may occur as the hot melt adhesive cools from an elevated temperature to room temperature.

It will be appreciated that applying a first adhesive composition to the outer layer of the construction panel to fill the plurality of recesses with the first adhesive composition and to provide a uniform outer layer is different to the varnishing, lacquering or painting of the surface of a construction panel as disclosed in the prior art methods. Typical varnishing, lacquering or painting methods merely involve the coating of a panel surface and generally coat the uppermost surface of the wood strands in the outer layer but without sufficiently filling the plurality of recesses to form a uniform outer layer. Indeed, the prior art methods would not fill the recesses and therefore would not generate a flat, smooth surface on which a further bonding surface can be formed. The varnishing, lacquering or painting the surface do not act to lock the wood strands in place but are generally designed to provide an improved aesthetic appearance.

The drying step has a time duration suitable for allowing the adhesive to fill the plurality of recesses and cure/set so as to lock in the wood strands in the outer layer. In some embodiments, the drying step is a time duration of from about 5 seconds to about 86400 (24 hours) from about 5 seconds to about 18000 seconds (5 hours), from about 5 seconds to about 3600 seconds (1 hour), from about 5 seconds to about 1800 seconds (30 minutes), from about 5 seconds to about 600 seconds (10 minutes), from about 5 seconds to about 300 seconds, from about 5 seconds to about 60 seconds or from about 5 seconds to about seconds. In other embodiments, the drying step has a time duration of from about 1 second to about 5 seconds, from about 1 second to about 30 seconds or from about 1 second to about 60 seconds. In some embodiments, the drying step has a time duration of from about 5 seconds to about 120 seconds.

In alternate embodiments, the uniform outer layer is not dried prior to application of the second adhesive composition. In such embodiments, the adhesive is not allowed to significantly cure or set before the step of applying a second adhesive composition to the uniform outer layer is performed. This may be achieved by performing the step of applying a first adhesive composition to the outer layer to provide the uniform outer layer and then immediately performing the step of applying a second adhesive composition to the uniform outer layer.

In embodiments of the present invention, the first adhesive composition is applied across the entire outer layer of the construction panel (i.e. complete coverage of the outer surface of the construction panel). This ensures that all the wood stands in the outer layer of the construction panel become “locked in” and secured to the body of the construction panel. In further embodiments of the present invention, the second adhesive composition is applied across the entire uniform outer layer of the construction panel (i.e. complete coverage of the uniform outer layer of the construction panel). This ensures that the protective film becomes effectively bonded across the entire panel surface which is being protected and thereby provides complete protection. In particularly advantageous embodiments of the present invention, the first adhesive composition is applied across the entire outer layer of the construction panel and the second adhesive composition is applied across the entire uniform outer layer.

In further embodiments of the present invention, the step of applying the first adhesive composition to the outer layer comprises spraying, brushing, trowelling, bead-jetting, nozzle dispensing, roller coating (e.g. reverse or forward roller coating), curtain coating, solid application or any combination thereof. In preferred embodiments of the present invention, applying a first adhesive composition to the outer layer is performed by spray coating. Spray coating may involve spraying the first adhesive composition onto the outer layer of the construction panel with at least one spray head. The spray head may be a spiral spray head. In other embodiments, applying a first adhesive composition to the outer layer is performed by reverse heated roller coating.

It has been found that spray coating provides a particularly effective method of sealing/priming an uneven surface and controlling the application of adhesive to the outer layer to ensure that adhesive penetrates into the recesses in the outer layer and fills the recesses without requiring excess adhesive. This allows for the wood strands to become “locked in” place while also ensuring that that an appropriate coat weight of adhesive is applied.

In embodiments of the present invention, the method further comprises applying a compression force to the outer layer of the construction panel after application of the first adhesive composition to compress the first adhesive composition into the plurality of recesses and form the uniform outer layer. The compression force ensures that the first adhesive composition enters and fills the plurality of recesses. In embodiments, the compression force is from about 10 kPa to about 300 kPa, from about 20 kPa to about 200 kPa or from about 50 kPa to about 100 kPa. The compression force may be provided by any suitable compression means, for example, a compression plate or compression roller.

In further embodiments of the present invention, the first adhesive composition is applied at a coat weight of from about 5 to about 100 grams per square metre, for example from about to about 70 grams per square metre or from about 10 to about 55 grams per square metre. In some embodiments of the present invention, the first adhesive composition is applied at a coat weight of from about 10 to about 40 grams per square metre, preferably at a coat weight of from about 20 to about 30 grams per square metre.

As discussed previously, it is important that the protective film becomes sufficiently bound to the panel so as to remain in place and prevent water ingress but also that the protective film can subsequently be removed without splintering of the construction panel surface. Careful control of the coat weight of the first adhesive composition, for a given construction panel having specification structural characteristics (e.g. recesses depths etc), allows for the plurality of recesses to be filled and to generate the uniform outer layer, without application of excessive amounts of adhesive, which may ultimately lead to the protective film becoming very strongly bound to the construction panel. A protective film that is very strongly bound to the panel may not be easily removable, and if it is, may apply more force to the individual woods strands upon its removal leading to a greater likelihood of splintering at the surface. Moreover, the use of excessive amounts of adhesive can cause the build-up of excessive adhesive on the panel surface which has detrimental effects to the downstream panel processing and the production line as a whole.

In some embodiments, the first adhesive composition is applied at a coat weight of from about 5 to about 100 grams per square metre by spray coating. Typically, the first adhesive composition may be applied at a coat weight of from about 10 to about 40 grams per square metre by spray coating or at a coat weight of from about 20 to about 30 grams per square metre by spray coating.

In embodiments of the present invention, the viscosity of the first adhesive composition is from about 1000 to about 3100 cPs at 160° C. Carefully selecting the viscosity of the first adhesive composition may allow it to penetrate into the plurality of recesses while also sufficiently coating the top surface of the wood strands, thus providing the uniform outer layer.

In embodiments of the present invention, the step of applying a first adhesive composition may be performed at an elevated temperature. Suitable temperatures may depend on the type of adhesive composition(s) being used and may include, but are not limited to, a temperature of from about 50° C. to about 200° C., from about 50° C. to about 150° C., from about 100° C. to about 200° C., from about 120° C. to about 180° C., from about 40° C. to about 160° C. Typically, the temperature of the first adhesive composition may be from about 125° C. to about 175° C. or from about 80° C. to about 150° C. For example, the step of applying a first adhesive composition to the outer layer of the construction panel may be performed at a temperature of about 150° C.

In further embodiments, the step of applying a first adhesive composition may be performed at an elevated temperature via spray coating. For example, the step of applying a first adhesive composition to the outer layer of the construction panel may be performed by spray coating at a temperature from about 50° C. to about 150° C.

In still further embodiments, the outer layer of the construction panel has an elevated temperature prior to the step of applying the first adhesive composition (i.e. the surface of the panel may be pre-heated prior to application of the first adhesive composition). This is useful in overcoming problems/issues associated with applying hot melt adhesives to the outer layer of a construction panel wherein the outer layer of the construction panel is at ambient temperature. For example, increasing the temperature of the outer layer of the construction panel to which the adhesive is to be applied may aid the flow and adhesive properties of the adhesive composition and prevent stringing of the adhesive composition during application. The degree of temperature elevation will depend on the adhesive being used. Suitable temperatures at which to elevate the outer layer of a construction panel prior to applying an adhesive composition may include a temperature of from about 5° C. to about 60° C., more preferably from about 40° C. to about 60° C. The construction panels may be heated using any suitable heating means, for example, radiant gas heaters.

In embodiments of the present invention, the step of applying the second adhesive composition to the uniform outer layer comprises spraying, brushing, trowelling, bead-jetting, nozzle dispensing, roller coating (e.g. reverse or forward roller coating), curtain coating, solid application or any combination thereof the second adhesive composition onto the uniform outer layer. In preferred embodiments of the present invention, the step of applying the second adhesive composition to the uniform outer layer comprises roller coating, for example, reverse roller coating. The above methods provide a means for applying a smooth consistent layer of adhesive onto the uniform outer layer to generate a suitable bonding surface for application of the protective film. The methods also allow for control of the coat weight of second adhesive composition, which is important in achieving a sufficient but temporary adhesion of the protective film.

In embodiments of the present invention, the second adhesive composition is applied to the uniform outer layer at a coat weight of from about 5 to about 100 grams per square metre, for example from about 5 to about 70 grams per square metre or from about 10 to about 55 grams per square metre. In some embodiments of the present invention, the second adhesive composition is applied to the uniform outer layer at a coat weight of from about 10 to about 40 grams per square metre, preferably at a coat weight of from about 20 to about grams per square metre. Applying the second adhesive composition to the uniform outer layer provides the bonding surface for bonding the protective film to the construction panel. The coat weight may therefore affects how strongly the protective film is bound to the panel. It is advantageous to use a coat weight that allows the protective film to be easily peeled off once its use has been fulfilled (i.e. temporary adhesion and peel off).

In other embodiments, the second adhesive composition is applied at a coat weight of from about 5 to about 100 grams per square metre by roller coating. For example, the first adhesive composition may be applied at a coat weight of from about 10 to about 40 grams per square metre by roller coating, preferably at a coat weight of from about 20 to about 30 grams per square metre by roller coating. In alternative embodiments, the second adhesive composition is applied at a coat weight of from about 5 to about 100 grams per square metre by spray coating. For example, the first adhesive composition may be applied at a coat weight of from about 10 to about 40 grams per square metre by spray coating, preferably at a coat weight of from about 20 to about 30 grams per square metre by spray coating.

In further embodiments, the step of applying a second adhesive composition to the uniform outer layer may be performed at an elevated temperature. Suitable temperatures may depend on the type of adhesive composition(s) being used and may include, but are not limited to, a temperature of from about 50° C. to about 200° C., from about 50° C. to about 150° C., from about 100° C. to about 200° C., from about 120° C. to about 180° C., from about 40° C. to about 160° C. Typically, the temperature of the further adhesive composition may be from about 125° C. to about 175° C. or from about 80° C. to about 150° C. For example, the step of applying a second adhesive composition to the uniform outer layer may be performed at a temperature of about 150° C.

In still further embodiments, the uniform outer layer of the construction panel has an elevated temperature prior to the step of applying the second adhesive composition. Analogous to the application of the first adhesive composition, this is useful in overcoming problems/issues associated with applying hot melt adhesives to the uniform outer layer wherein the uniform outer layer is at ambient temperature. For example, increasing the temperature of the uniform outer layer to which the adhesive is to be applied may prevent stringing of the second adhesive composition during application. The degree of temperature elevation will depend on the adhesive being used. Suitable temperatures at which to elevate the uniform outer layer prior to applying an adhesive composition may include a temperature of from about 5° C. to about 60° C., more preferably from about 40° C. to about 60° C. The uniform outer later may be heated using any suitable heating means, for example, radiant gas heaters.

In embodiments of the present invention, the first and second adhesive composition are the same adhesive composition. In alternate embodiments, first and second adhesive composition are different adhesive compositions.

Suitable adhesive compositions for the first and/or second adhesive composition may include, but are not limited to, a hot melt adhesive, drying adhesive, pressure sensitive adhesive, contact adhesives or any combination thereof.

In embodiments of the present invention, the first adhesive composition is a hot melt adhesive. Advantageously, hot melt adhesives have been found to be effective at penetrating into and filling the recesses between the wood strands in the construction panels, thereby generating a uniform outer layer.

Similarly, the second adhesive composition may be a hot melt adhesive. In some embodiments, both the first and second adhesive compositions are hot melt adhesives.

Where an adhesive composition is a hot melt adhesive, the composition may include waxes, resins, ethylene-vinyl acetate copolymers, polyolefins, polyamides, polyesters, polyurethanes, styrene block copolymers, polycaprolactones, polycarbonates, fluorinated polymers, silicone based polymers, polypyrroles or any combination thereof.

Preferably, the first and/or second adhesive composition is an ethylene-vinyl acetate copolymer based adhesive optionally wherein the viscocity of the ethylene-vinyl acetate copolymer based adhesive is from about 1000 to about 3100 cPs @ 160° C., from about 1000 to about 1500 cPs @ 170° C., from about 1500 to about 2500 cPs @ 150° C. or from about 1500 to about 2500 cPs @ 180° C.

Examples of the adhesive compositions used to bond a protective film to a construction panel including their respective suppliers, grades and viscosity measurements, are as illustrated in the Table 1 below.

TABLE 1
Examples of adhesive compositions

| Supplier | Grade | Viscosity |
|---|---|---|
| Abrabond ™ | AB464HM | 1700 cPs @ 160° C. |
| Adhesives direct ™ | AD826 | 1750 cPs @ 160° C. |
| Adhesives direct ™ | AD851 | 1900 cPs @ 160° C. |
| Alphabond Adhesives ™ | Fastlock 66x | 1850 cPs @ 160° C. |
| Alphabond Adhesives ™ | Fastlock 30029 | 1700 cPs @ 160° C. |
| Beardow Adams ™ | Prodas 2308 | 1795 cPs @ 160° C. |
| Beardow Adams ™ | Prodas 1507 | 1700 cPs @ 160° C. |
| Beardow Adams ™ | Prodas 2247 | 3080 cPs @ 160° C. |
| Bostik ™ | Thermogrip 9691 | 1300 cPs @ 170° C. |
| Caswell Adhesives ™ | Premiermelt 178PA | 1450 cPs @ 160° C. |
| Colquimica ™ | K-melt C2310 | 1000 cPs @ 160° C. |
| HB Fuller ™ | Swift-therm 9119 | 2200 cPs @ 150° C. |
| Jowat Adhesives ™ | Jowatherm 261.40 | 1800 cPs @ 180° C. |

In embodiments of the present invention, the first adhesive composition is a UV (ultra-violet) curable adhesive. A UV curable adhesive is one which hardens under irradiation of UV (ultraviolet) light. For example, the curing may occur by the UV light initiating a photochemical reaction that generates a cross-linked network of polymers.

For avoidance of doubt, a hot melt adhesive may also be a UV curable adhesive. For example, the adhesive may be applied hot and partially set upon cooling but then further harden under UV irradiation.

Where the first adhesive composition is a UV curable adhesive, the method preferably comprises a step of curing the UV curable adhesive. This step may be performed prior to the step of applying the second adhesive composition. The step of curing the UV curable adhesive may involve irradiating the first adhesive composition with UV light, e.g. using a UV lamp.

In embodiments of the present invention, there is a delay between the steps of applying the first adhesive composition to the outer layer and applying the second adhesive composition to the uniform outer layer. In other words, a period of time is allowed to elapse between applying the first adhesive composition and applying the second adhesive composition to the uniform outer layer. The delay may be from about 5 seconds to about 86400 (24 hours), from about 5 seconds to about 18000 seconds (5 hours), from about 5 seconds to about 3600 seconds (1 hour), from about 5 seconds to about 1800 seconds (30 minutes), from about 5 seconds to about 600 seconds (10 minutes), from about 5 seconds to about 300 seconds, from about 5 seconds to about 60 seconds or from about 5 seconds to about 30 seconds. In other embodiments, the delay may of from about 1 second to about 5 seconds, from about 1 second to about 30 seconds or from about 1 second to about 60 seconds. In some embodiments, the drying step has a time duration of from about 5 seconds to about 120 seconds. In some embodiments, the construction panel is conveyed (moved) between applying the first adhesive composition to the outer layer and applying the second adhesive composition to the uniform outer layer. In such embodiments, the delay may be controlled based on the speed of the conveyer and the distance the panel travels. The delay may allow for the drying of the first adhesive composition as described above. Alternatively, the delay may not be related to the drying of the first adhesive composition.

In embodiments of the present invention, the protective film is selected from the consisting of a polyethylene based material, polypropylene based material, polyvinyl chloride based material, polyethylene terephthalate based material, polyvinylidene chloride based material, ethylene vinyl alcohol based material, ethylene vinyl acetate based material or any combination thereof. Such protective films may also be corona treated and/or UV stabilized prior to being used in the present method or panels.

In some embodiments, the protective film has a film weight of from about 60 grams per square metre to about 140 grams per square metre, from about 60 grams per square metre to about 80 grams per square metre, from about 60 grams per square metre to about 100 grams per square metre, from about 60 grams per square metre to about 120 grams per square metre, from about 80 grams per square metre to about 100 grams per square metre, from about 70 grams per square metre to about 100 grams per square metre or more preferably, from about 70 grams per square metre to about 90 grams per square metre.

Examples of the protective films applied to a surface of the construction panel including their respective suppliers, grades and description, are as illustrated in the Table 2 below.

TABLE 2
Examples of protective films

| Supplier | Grade | Description |
|---|---|---|
| Pavag Folien AG ™ | Rolamit | Cross laminated polyethylene |
| | Standardfolie | polymers. |
| | | UV stabilised and fully corona |
| | | treated. |
| | | Available range 60-120 |
| | | grams per square metre. |
| | | Typically 70-80 grams per |
| | | square metre used. |
| Valeron ® | Valcross | Cross laminated polyethylene |
| Strength Films | | polymers. |
| | | UV stabilised and fully corona |
| | | treated. |
| | | Available range 60-120 |
| | | grams per square metre. |
| | | Typically 70-80 grams per |
| | | square metre used. |
| Milspeed ™ | HDPE Film | Reprocessed high density |
| | | polyethylene with ionomer |
| | | resin, ethylene vinyl acetate |
| | | and polyethylene terephthalate |
| | | laminated with a polyester |
| | | surface to provide good slip |
| | | resistance. |
| | | Available range 60-140 |
| | | grams per square metre. |
| | | Typically 80-90 grams per |
| | | square metre used. |
| Don & Low ™ | Lobrene fabric | Coated industrial fabric coated |
| | | one side with clear |
| | | polypropylene and UV |
| | | stabilised. |
| | | Available range 60-120 |
| | | grams per square metre. |
| | | Typically 70-90 grams per |
| | | square metre used. |

In embodiments of the present invention, applying the protective film to the bonding surface to bond the protective film to the construction panel comprises applying a pressure of from about 20 kPa to about 800 kPa, from about 100 kPa to about 700 kPa, from about 200 kPa to about 700 kPa, from about 300 kPa to about 600 kPa, from about 350 kPa to about 550 kPa to the protective film or, more preferably, a pressure of from about 400 kPa to about 500 kPa. Even more preferably, applying the protective film to the bonding surface to bond the protective film to the construction panel comprises applying a pressure of from about 400 kPa, about 450 kPa or about 500 kPa to the protective film. The pressure can be applied using any suitable pressure applying means, for example, press down rubber wheels or pressure plates.

In embodiments of the present invention, the method further comprises the step of selectively applying a third adhesive composition to a peripheral region of the bonding surface and/or selectively applying a third adhesive composition to a peripheral region of a surface of the protective film before applying the protective film to the bonding surface of the construction panel.

As used herein, the term “selectively applying” refers to a focused application of an adhesive composition to a specific area on a surface of a construction panel or protective film. This may involve precisely controlling the application of the adhesive composition onto the specific area on the surface of the construction panel or protective film. This may be achieved using a variety of application techniques including, but not limited to, brushing/trowelling, spraying, bead-jetting, nozzle dispensing, roller coating, curtain coating, solid application or any combination thereof.

As used herein, the term “peripheral region” may refer to an area of the bonding surface which is, generally, located towards an outermost portion of the construction panel. It will also be appreciated that, where used with reference to a protective film, the term “peripheral region” may refer to an area of a surface of a protective film which is, generally, located towards an outermost portion of the surface of the protective film.

It will also be appreciated that the peripheral region may extend from an edge of the panel and extend partially across the bonding surface. In embodiments, the peripheral region may extend from the edge of the construction panel and across from about 0.1% to about 25% of the width of the bonding surface. In some embodiments, the peripheral region may extend from the edge of the construction panel and across from about 0.2% to about 10%, from about 0.5% to about 2%, from about 1% to about 5%, from about 1% to about 10%, from about 1% to about 15%, from about 5% to about 10%, from about 5% to about 15%, from about 5% to about 20%, from about 5% to about 25%, from about 10% to about 15%, or from about 10% to about 20% of the width of the bonding surface.

Alternatively, the peripheral region may be inset from an edge of the panel and extend partially across the bonding surface. In some embodiments, the peripheral region may be inset from an edge of the panel by a distance of from about 0.05% to about 5% of the width of the construction panel. More preferably, the peripheral region may be inset from an edge of the panel by a distance of from about 0.5% to about 2.5% of the width of the panel.

In embodiments of the first aspect of the present invention, the method further comprises the step of sealing or priming the outer layer before applying the first adhesive composition to the outer layer. It will be appreciated that sealing or priming typically involves applying an adhesive composition (e.g. any adhesive as described herein) at a coat weight that does not sufficiently fill the plurality of recesses to generate a “uniform outer layer” but instead forms a primer/sealing layer on the outer layer and/or provides an initial sealing effect before the step of applying the first adhesive composition to the outer layer is performed. That is, the adhesive composition used during the sealing or priming step may generally be applied at a coat weight value that is less than the coat weight value required to fill the plurality of recesses and generate the uniform outer layer for a given construction panel. The exact coat weight required during the sealing or priming step will depend on a range of factors and the specific application requirements needed (e.g. size of recesses etc). The adhesive composition used during this sealing or priming step may be applied at a coat weight of from about 0.1 to about 40 grams per square metre, for example from about 1 to about 40 grams per square metre, from about 1 to about 20 grams per square metre or from about 2 to about grams per square metre. In some embodiments, the adhesive composition used during this sealing or priming step may be applied at a coat weight of from about 1 to about 5 grams per square metre, from about 2 to about 4 grams per square metre, from about 4 to about 8 grams per square, from about 5 to about 10 grams per square metre, or from about 6 to about 10 grams per square metre.

In some embodiments of the first aspect of the invention, there is provided a method of applying a protective film to an OSB construction panel, the OSB construction panel comprising an outer layer, the outer layer comprising overlapping wood strands and a plurality of recesses formed between the overlapping wood strands, wherein the method comprises the steps of a) applying a first adhesive composition to the outer layer at a coat weight of 10 to 40 grams per square metre, preferably 20 to 30 grams per square metre, by spray coating to fill the plurality of recesses with the first adhesive composition to provide a uniform outer layer; b) applying a second adhesive composition to the uniform outer layer at a coat weight of 10 to 40 grams per square metre, preferably 20 to 30 grams per square metre, by roller coating to provide a bonding surface; and c) applying the protective film to the bonding surface to bond the protective film to the construction panel, preferably wherein the first and second adhesive compositions are the same adhesive composition. In such embodiments, the plurality of recesses in the outer layer have a depth of from about 3 mm to about 7 mm or of from about 4 mm to about 6 mm.

In a second aspect of the present invention, there is provided a protected construction panel obtained or obtainable by the method according to the first aspect of the invention.

In a third aspect of the present invention, there is provided a protected construction panel comprising: an outer layer comprising overlapping wood strands and a plurality of recesses formed between the overlapping wood strands; a first adhesive composition layer located on the outer layer and extending into the plurality of recesses to fill the plurality of recesses to provide a uniform outer layer, a second adhesive composition layer located on the uniform outer layer to provide a bonding surface, and a protective film layer located on the bonding surface.

In embodiments of the third aspect of the invention, the first adhesive composition layer extends into the plurality of recesses to completely fill the plurality of recesses to provide the uniform outer layer.

In embodiments of the third aspect of the invention, a third (peripheral) adhesive composition layer is located between the bonding surface and the protective film layer. In such embodiments of the third aspect of the invention, the third adhesive composition layer extends from an edge of the panel and across from about 0.1% to about 25% of the width of the bonding surface. In further embodiments of the third aspect of the invention, the third adhesive composition layer may extend from the edge of the construction panel and across from about 0.2% to about 10%, from about 0.5% to about 2%, from about 1% to about 5%, from about 1% to about 10%, from about 1% to about 15%, from about 5% to about 10%, from about 5% to about 15%, from about 5% to about 20%, from about 5% to about 25%, from about 10% to about 15%, or from about 10% to about 20% of the width of the bonding surface.

In embodiments of the third aspect of the invention, the construction panel is Oriented Strand Board (OSB). For example, any type of Oriented Strand Board as defined by European Standard EN300 (OSB-Definitions, classification and specifications). In other embodiments of the third aspect of the present invention, the construction panel is a non-Orientated Strand Board, for example, Waferboard.

In embodiments of the third aspect of the invention, the plurality of recesses in the outer layer have a depth of from about 0.5 mm to about 20 mm, e.g. of from about 1 mm to about 10 mm, such as of from about 2 mm to about 8 mm. Preferably, the plurality of recesses in the outer layer have a depth of from about 4 mm to about 6 mm.

In embodiments of the third aspect of the invention, the overlapping wood strands are selected from any suitable type of wood strand or a combination of one or more suitable types of suitable wood strand. In embodiments of the third aspect of the invention, the overlapping wood strands are selected from the group consisting of spruce wood strands, fir wood strands, pine wood strands, larch wood strands, beech wood strands, aspen wood strands, birch wood strands, willow wood strands, alder wood strand or any combination thereof. In embodiments of the third aspect of the invention, the wood strands comprise recycled timber.

In embodiments of the third aspect of the invention, the first adhesive composition layer covers the entire outer layer of the construction panel. In further embodiments of the third aspect of the invention, the second adhesive composition layer covers the entire uniform outer layer of the construction panel.

In embodiments of the third aspect of the present invention, a primer/sealing layer is located between the outer surface and the first adhesive composition layer. It will be appreciated that the primer/sealer layer does not fill the recesses to an extent sufficient to generate the uniform outer layer (i.e. does not fill the recesses to the extent of that of the first adhesive composition layer). The adhesive composition used for the primer/sealing layer may generally have a coat weight value that is less than the coat weight of the first adhesive composition layer.

In embodiments of the third aspect of the invention, the first adhesive composition layer has a coat weight of from about 5 to about 100 grams per square metre, for example from about to about 70 grams per square metre or from about 10 to about 55 grams per square metre. In some embodiments of the third aspect of the invention, the first adhesive composition layer has a coat weight of from about 10 to about 40 grams per square metre, preferably at a coat weight of from about 20 to about 30 grams per square metre.

In embodiments of the third aspect of the invention, the second adhesive composition layer has a coat weight of from about 5 to about 100 grams per square metre, for example from about 5 to about 70 grams per square metre or from about 10 to about 55 grams per square metre. In some embodiments of the third aspect of the invention, the second adhesive composition layer has a coat weight of from about 10 to about 40 grams per square metre, preferably at a coat weight of from about 20 to about 30 grams per square metre.

In embodiments of the third aspect of the invention, the first and second adhesive composition layers comprise the same adhesive composition (e.g. are formed from the same adhesive composition). In alternate embodiments, first and second adhesive composition layers do not comprise the same adhesive composition (e.g. are formed from different adhesive compositions).

Suitable adhesive compositions for the first and/or second adhesive composition layer may include, but are not limited to, a hot melt adhesive, drying adhesive, pressure sensitive adhesive, contact adhesives or any combination thereof.

Where an adhesive composition is a hot melt adhesive, the composition may include waxes, resins, ethylene-vinyl acetate copolymers, polyolefins, polyamides, polyesters, polyurethanes, styrene block copolymers, polycaprolactones, polycarbonates, fluorinated polymers, silicone based polymers, polypyrroles or any combination thereof.

In embodiments of the third aspect of the invention, the first adhesive composition layer comprises a UV (ultra-violet) curable adhesive. Preferably the first adhesive composition layer comprises a cured UV curable adhesive.

In embodiments of the third aspect of the invention, the protective film is selected from a polyethylene based material, polypropylene based material, polyvinyl chloride based material, polyethylene terephthalate based material, polyvinylidene chloride based material, ethylene vinyl alcohol based material, ethylene vinyl acetate based material or any combination thereof. Such protective films may also be corona treated and/or UV stabilized.

In some embodiments third aspect of the invention, the protective film has a film weight of from about 60 grams per square metre to about 140 grams per square metre, from about 60 grams per square metre to about 80 grams per square metre, from about 60 grams per square metre to about 100 grams per square metre, from about 60 grams per square metre to about 120 grams per square metre, from about 80 grams per square metre to about 100 grams per square metre, from about 70 grams per square metre to about 100 grams per square metre or more preferably, from about 70 grams per square metre to about 90 grams per square metre.

It will be appreciated that other features described in relation to the first aspect of the invention may also be applicable to the third aspect of the invention. For the avoidance of doubt, where applicable, all features described in relation to the first aspect are intended to be disclosed in relation to the third aspect of the invention.

### BRIEF DESCRIPTION OF FIGURES

Some embodiments of the present invention are described more fully hereinafter with reference to the accompanying figures. In the figures, dimensions may be exaggerated for clarity of illustration.

FIG. 1 shows a process flow diagram illustrating a prior art method for applying a protective film to an OSB construction panel. The steps are shown in relation to a cross sectional view of the surface of the OSB construction panel.

FIG. 2 shows a process flow diagram illustrating the removal of a protective film that has been applied to an OSB construction panel via the prior art process described in relation to FIG. 1.

FIG. 3 shows a process flow diagram illustrating the steps involved in an embodiment of the present invention. The steps are shown in relation to a cross sectional view of the surface of the OSB construction panel.

FIG. 4 shows a process flow diagram illustrating the removal of a protective film that has been applied according to the embodiment described in relation to FIG. 3.

FIG. 5 shows an exemplary process flow diagram illustrating an apparatus used to apply a protective film to the surface of a construction panel according to an embodiment of the present invention.

FIG. 6 shows a heater roller coater used to apply adhesive composition to the surface a construction panel.

In the following detailed description, only certain embodiments of the present invention have been shown and described, simply by way of illustration. As those skilled in the art would realise, the described embodiments may preferably be modified in various different ways, all without departing from the spirit or scope of the present invention. Accordingly, the drawings and description are to be regarded as illustrative in nature and not restrictive.

### DETAILED DESCRIPTION OF THE INVENTION

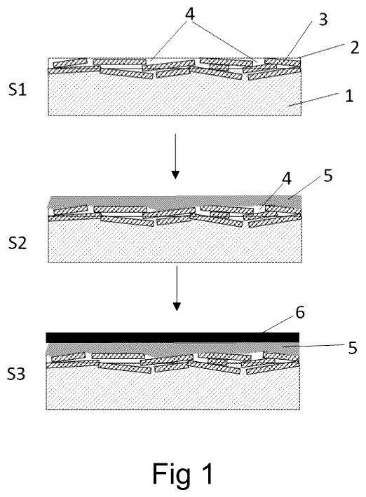

FIG. 1 shows a process flow diagram illustrating a typical prior art method for applying a protective film to an OSB construction panel. Each step shows a cross sectional view of the surface of an OSB construction panel.

At step S1, there is provided an OSB construction panel (1) with an outer (top) layer 2. The outer layer (2) is formed from a plurality of overlapping wood strands (3) which lie unevenly across each other resulting in a rough and variegated top surface. In between the wood strands (3) there are a plurality of recesses (4). Typically, the recesses have a depth of from about 4 mm to about 6 mm.

At step S2, a first adhesive composition (5) is applied onto the top surface of the OSB construction panel using a heater roller coater. The roller is only able to apply adhesive to the wood strands at the upper most edge of the outer layer and adhesive does not penetrate into the recesses (4) contained between the wood strands. Instead, the adhesive forms an uneven bonding layer that is only in contact with the protruding uppermost portions of the wood strands and, sometimes, limited to the edge of the outer layer.

At step S3, the protective film (6) is applied to adhesive composition (5). Pressure is applied to the protective film (6) to ensure it bonds to the construction panel (1).

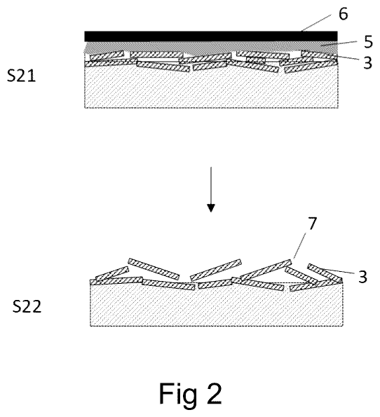

FIG. 2 illustrates the surface of the OSB construction panel from FIG. 1 during removal of the protective film. At step S21, there is provided a protected construction panel produced by the prior art method described in steps S1-S3. At step S22, the protective film is peeled away and removed. The action of removing the protective film results in force being applied to the individual wood strands (3) and the wood strands being pulled away from the surface of the construction panel, thereby generating a rough or splintered surface (7).

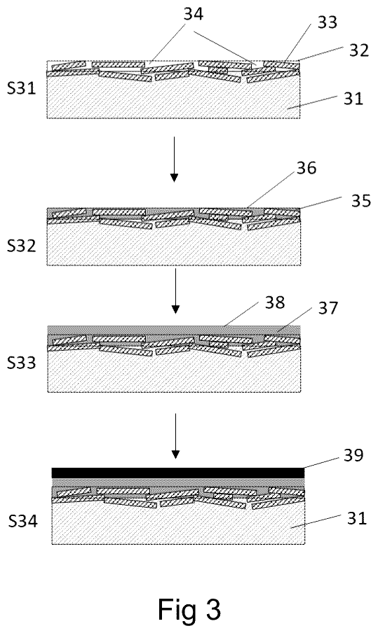

FIG. 3 illustrates a process flow diagram showing a cross sectional view of the surface of an OSB construction panel during an exemplary embodiment of the invention.

At step S31, there is provided an OSB construction panel (31) with an outer (top) layer (32). Analogous to step S1, the outer layer (32) is formed from a plurality of overlapping wood strands (33) which lie unevenly across each other resulting in a rough and variegated top surface. In between the wood strands (33) there are a plurality of recesses (34). Typically, the recesses have a depth of from about 4 mm to about 6 mm.

At step S32, a first adhesive composition (35) is applied onto the OSB construction panel filling, in this case completely filling, the recesses (34) and lightly coating wood strands (33), thus evenly sealing/priming the surface and creating a uniform outer layer (36). Typically, the first adhesive composition is sprayed onto the construction panel using a spiral spray head. Preferably, the first adhesive composition is a hot melt adhesive applied at a coat weight between 20 to 30 grams per square metre. Prior to step S32, there may optionally have been a sealing or priming step performed wherein an additional adhesive composition is applied to the outer layer (32), preferably using a spray head, prior the application of the first adhesive composition (35). It will be appreciated that this sealing or priming step would not create a uniform outer layer or completely fill the recesses (34).

At step S33, a second adhesive (37) is applied onto the uniform outer layer (36) to generate a bonding surface (38). Typically, the second adhesive composition is applied with a heater roller coater between 5 seconds and 120 seconds after application of the first adhesive composition (35). In certain embodiments, the uniform outer layer (36) undergoes a step of drying before the second adhesive is applied. The second adhesive composition is preferably the same adhesive as the first adhesive, but it may also be a different adhesive. The second adhesive preferably has a coat weight of from 20 to 30 grams per square metre. It will be appreciated that in alternative embodiments, the first adhesive could be applied via roller coating and the second adhesive could be applied by spray coating.

At step S34, a protective film (39) is applied to bonding surface (38). Pressure is typically applied to the protective film (39) to ensure it bonds to the construction panel (31).

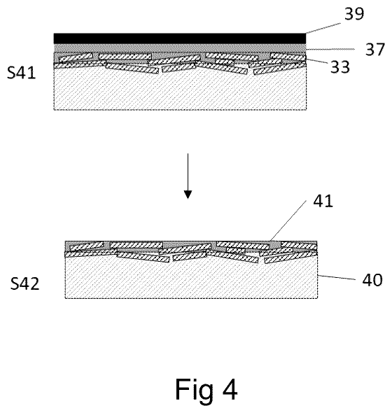

FIG. 4 illustrates the surface of the OSB construction panel from FIG. 3 during removal of the protective film. At step S41, there is provided a protected construction panel produced from steps S31-S34. At step S42, the protective film is peeled off removing the majority of adhesive but leaving a sealed construction panel (40) with a smooth outer layer (41). The wood strands remain locked in place and the recesses remain filled with adhesive.

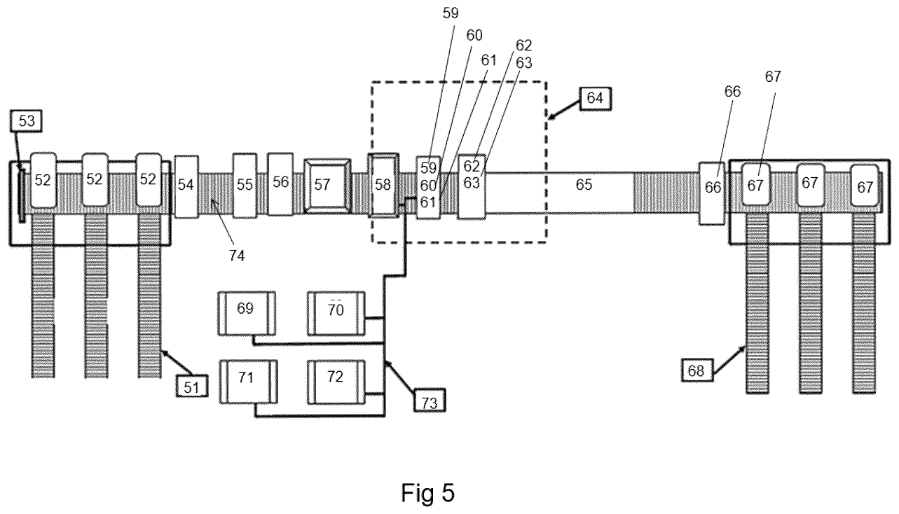

FIG. 5 shows an exemplary process flow diagram illustrating the apparatus used to apply a protective film to the surface of a construction panel according to an embodiment of the present invention.

OSB Construction panels (not shown) are delivered and loaded on to a feed conveyor system (51). Where the construction panels are delivered in packaging (e.g. bearers, slats, strapping, identification or labels), before being removed, which is done manually. The panels are loaded, using a forklift truck or any other suitable means, onto the feed conveyer system (51) in either single stack or multiple stack arrangements. The feed conveyor system (51) transports the construction panels automatically towards an in-feed vacuum pick-and-place stacking system (52) which in turn transfers the construction panels onto a machine bed (74). Again, the construction panels are loaded on to the machine bed (74), automatically, in either single stack or as multiple stack arrangement.

An in-feed panel pusher (53) then conveys the construction panels along the machine bed (74) and into an in-feed nip roller (54). The construction panels are then conveyed through a brush roller (55) which cleans the surface of the panels. The brush roller (55) is also fitted with an extraction system to remove any dust on the panel surface. The dust is removed and taken away via an extraction pipe.

The construction panels are then automatically conveyed from the brush roller (55) into a governor roller (56). The governor roller (56) drives the construction panels along the remainder of the machine bed (74) and controls the line speed. The panels are automatically conveyed from the governor roller (56) into a gas radiant heater (57) where the surface of the construction panels is heated to approximately 45° C. From the gas radiant heater station (57), the construction panels are then fed into a spiral spray head (58), where a first adhesive composition is applied to the entire top surface of the construction panels to fill the recesses in the outer layer. Where the adhesive composition is a hot melt adhesive, heated hoses (73) are used to supply the spray head (58) with the adhesive composition from an adhesive melting tank (69).

After application of the first adhesive composition, the adhesive may optionally be dried or partially dried. Drying can be performed, for example, by using fans, heated fans or convection ovens. Where the first adhesive compositions is a UV curable adhesive, the adhesive may optionally be cured by irradiation with UV light, for example using a UV lamp.

The construction panels are then automatically conveyed from the spray head (58) into a heater roller coater (59) and/or a second spiral spray head (60) where a further adhesive is applied and/or sprayed over the entire surface of the construction panel Where the adhesive composition is a hot melt adhesive, heated hoses (73) are used to supply the heater roller coater (59) and/or second spiral spray head (60) with the adhesive composition from adhesive melting tanks (70) and (71).

The adhesive composition application steps (59) and (60) can be used independently or together depending on the requirements of the construction panel being processed and the types of adhesives used.

The construction panels are then automatically conveyed from the heater roller coater (59) or spiral spray head (60) toward a heated oil roller (62), optionally via a bead jetting head (61) where an adhesive bead is jetted down along a peripheral region of the construction panels. Where the adhesive composition is a hot melt adhesive, heated hoses (73) are used to supply the bead jetting head (61) with the adhesive composition from an adhesive melting tank (72). A protective film is fed from a gantry and forced through a roller holder (64). The protective film is then fed around the heated oil roller (62) where the protective film is bonded to the surface of the construction panels under pressure.

The film-bonded construction panels are then automatically conveyed from the heated oil roller (62) into a system of press down rubber wheels (63) to apply pressure to the protective film.

The construction panels are then automatically conveyed from the pressed down rubber wheels (63) to a cutting/inspection table (65) where any excess protective film (e.g. overhanging film) is cut along edges of the construction panels with a sharp instrument before the construction panels are quality checked.

The construction panels are then automatically conveyed from the cutting inspection table (65) to an outfeed nip roller (66) which directs the construction panels to an outfeed pick and place stacking system (67) where the panels are restacked on to outfeed conveyors (68) in either single stack or multiple stack arrangements.

The stacks are then then conveyed from the outfeed conveyor (68) to a packing station, preferably via a forklift truck, where the packs are repackaged into their original/alternative packaging.

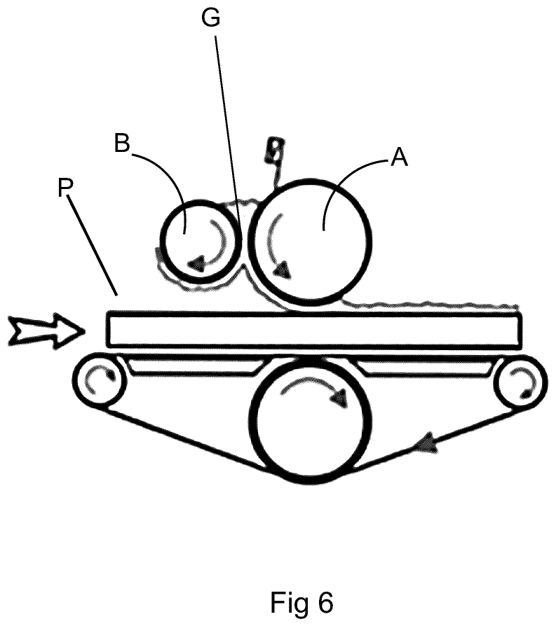

FIG. 6 illustrates an example of the heater roller coater (59) as described above. The heater roller coater is made up of a silicon roller (A) and steel dosing roller (B) which are both oil heated via an electric element that goes through the centre of each of the rollers. Each roller may be independently heated at a temperature ranging from about 80 to about 150° C. depending on the type of adhesive being applied.

A gap (G) between the rollers (i.e. the distance between the silicon roller (A) and the steel dosing roller (B)) is adjusted to control the coat weight of the adhesive composition being applied to the surface of the construction panel. Typically, gaps having measurements of from about 0 to about 3 mm are used but, generally, a heavy coat weight can be achieved by using a larger gap as compared to a lighter coat weight. Typical coat weights that can be achieved by the heater roller coater (8) range from about 20 to about 100 grams per square metre depending on the type of adhesive composition being used.

In use, an adhesive composition is pumped onto and into the space between the silicon roller (A) and the steel dosing roller (B). The adhesive composition is retained and prevented from spilling from the sides of the rollers by two pneumatic Teflon™ side plates (not shown) situated at each end of the rollers to create a well. The steel dosing roller (B) rotates in the opposite direction to the silicon roller (A) to force the adhesive composition between the rollers, down the well, through the gap (G) between the rollers and onto the surface of a panel (P) located beneath. As the machine bed, shown by (74) in FIG. 5, moves the panel (P) along the production line (in the direction of the arrow shown in FIG. 6) the adhesive composition is applied to the surface of the panel (P) via the silicon roller (A) at a coat weight corresponding to the gap (G) between the rollers.

It will be appreciated that the methods, materials and equipment/machinery described in relation to FIGS. 5 and 6 above, may be suitably modified by the skilled person to carry out a method according to the present invention.

1. A method of applying a protective film to a construction panel, the construction panel comprising an outer layer, the outer layer comprising overlapping wood strands and a plurality of recesses formed between the overlapping wood strands, wherein the method comprises the steps of:
a) applying a first adhesive composition to the outer layer to fill the plurality of recesses with the first adhesive composition to provide a uniform outer layer;
b) applying a second adhesive composition to the uniform outer layer to provide a bonding surface; and
c) applying the protective film to the bonding surface to bond the protective film to the construction panel.

2. The method according to claim 1, wherein the construction panel is oriented strand board (OSB) or waferboard.

3. The method according to claim 1, wherein the plurality of recesses in the outer layer have a depth of from about 0.5 mm to about 20 mm, preferably, from about 4 mm to about 6 mm.

4. The method according to claim 1, wherein the overlapping wood strands are selected from the group consisting of spruce wood strands, fir wood strands, pine wood strands, larch wood strands, beech wood strands, aspen wood strands, birch wood strands, willow wood strands, alder wood strand and any combination thereof.

5. The method according to claim 1, further comprising drying the uniform outer layer before applying the second adhesive composition.

6. The method according to claim 1, wherein applying a first adhesive composition to the outer layer is performed by spray coating.

7. The method according to claim 1, further comprising applying a compression force to the outer layer after application of the first adhesive composition to compress the first adhesive composition into the plurality of recesses and form the uniform outer layer; optionally wherein the compression force is from about 10 kPa to about 300 kPa.

8. The method according to claim 1, wherein the first adhesive composition is applied at a coat weight of from about 10 to about 40 grams per square metre, preferably at a coat weight of from about 20 to about 30 grams per square metre.

9. The method according to claim 1, wherein the viscosity of the first adhesive composition is from about 1000 to about 3100 cPs at 160° C.

10. The method according to claim 1, wherein the step of applying the first adhesive composition to the outer layer is at a temperature of from about 50° C. to about 150° C.

11. The method according to claim 1, wherein the step of applying the second adhesive composition to the uniform outer layer comprises spraying, brushing or roller coating the second adhesive composition onto the uniform outer layer.

12. The method according to claim 1, wherein the second adhesive composition is applied to the uniform outer layer at a coat weight of from about 5 to about 100 grams per square metre, preferably at a coat weight of from about 10 to about 40 grams per square metre.

13. The method according to claim 1, wherein applying the second adhesive composition to the uniform outer layer is performed at a temperature of from about 50° C. to about 150° C.

14. The method according to claim 1, wherein the first and second adhesive composition are the same adhesive composition or different adhesive compositions.

15. The method according to claim 1, wherein the first and/or second adhesive composition is a hot melt adhesive.

16. The method according to claim 1, wherein the first and/or second adhesive composition is selected from the group consisting of a ethylene-vinyl acetate copolymer based adhesive, polyolefin based adhesive, polyamide based adhesive, polyester based adhesive, polyurethane based adhesive, styrene block copolymer based adhesive, polycaprolactone based adhesive, polycarbonate based adhesive, fluorinated polymer based adhesive, silicone polymer based adhesive, polypyrrole based adhesive and any combination thereof.

17. The method according to claim 1, wherein the first adhesive composition is UV curable adhesive; optionally wherein the method further comprises the step of curing the UV curable adhesive, prior to applying the second adhesive composition.

18. The method according to claim 1, wherein there is a delay of from about 5 seconds to 120 seconds between the steps of applying the first adhesive composition to the outer layer and applying the second adhesive composition to the uniform outer layer.

19. The method according to claim 1, wherein the protective film is selected from the consisting of a polyethylene based material, polypropylene based material, polyvinyl chloride based material, polyethylene terephthalate based material, polyvinylidene chloride based material, ethylene vinyl alcohol based material, ethylene vinyl acetate based material and any combination thereof.

20. The method according to claim 1, wherein the protective film has a film weight of from about 60 grams per square metre to about 140 grams per square metre.

21. The method according to claim 1, wherein applying the protective film to the bonding surface to bond the protective film to the construction panel comprises applying a pressure of from about 20 kPa to about 800 kPa to said protective film.

22. The method according to claim 1, further comprising the step of selectively applying a third adhesive composition to a peripheral region of the bonding surface and/or selectively applying a third adhesive composition to a peripheral region of a surface of the protective film before applying the protective film to the bonding surface of the construction panel.

23. A protected construction panel obtained or obtainable by the method of claim 1.

24. A protected construction panel comprising:
an outer layer comprising overlapping wood strands and a plurality of recesses formed between the overlapping wood strands;
a first adhesive composition layer located on the outer layer and extending into the plurality of recesses to fill the plurality of recesses to provide a uniform outer layer;
a second adhesive composition layer located on the uniform outer layer to provide a bonding surface; and
a protective film layer located on the bonding surface.

25. The protected construction panel according to claim 24, further comprising a third (peripheral) adhesive composition layer located between the bonding surface and the protective film layer, optionally wherein the third adhesive composition layer extends from an edge of the panel and across from about 0.1% to about 25% of the width of the bonding
